(19) United States
(12) Patent Application Publication
(10) Pub. No.: US 2015/0128429 A1
(43) Pub. Date: May 14, 2015

(54) Power Tool and Transmission Thereof

(71) Applicants: Bosch Power Tools (China) Co., Ltd., Hangzhou, Zhejiang (CN); Robert Bosch GmbH, Stuttgart (DE)

(72) Inventors: Youmei Yan, Hangzhou (CN); Bo Zhen, Hangzhou (CN); Aigui Wang, Hangzhou (CN)

(21) Appl. No.: 14/382,527

(22) PCT Filed: Feb. 27, 2013
(86) PCT No.: PCT/CN2013/071915

§ 371 Date: Sep. 2, 2014

(30) Foreign Application Priority Data
Mar. 2, 2012 (CN) 201210054493.8

(51) Int. Cl. B23D 47/12; B25F 5/00; B23D 45/16; F16H 57/021

(52) U.S. Cl. CPC B23D 47/12; F16H 57/021; B25F 5/001; B23D 45/16
USPC 30/388; 74/412 R

(57) ABSTRACT

The disclosure relates to a transmission for a power tool, comprising an input gear driven by a driver, an intermediate shaft carrying first and second intermediate gears, the first intermediate gear being meshed with the input gear, an output shaft carrying an output gear, the output gear being meshed with the second intermediate gear for driving a tool bit, and proximal and distal bearings supporting proximal and distal ends of the intermediate shaft respectively. The first intermediate gear is formed with a receptacle portion which is recessed from a proximal end surface of the first intermediate gear in an axial direction towards a distal side, the proximal bearing being received in the receptacle portion at least in part in the axial direction. The disclosure also relates to a power tool comprising the above transmission. The disclosure provides a compact and robust structure.

### TECHNICAL FIELD

The disclosure relates to a transmission used in a power tool, and to a power tool, in particular an electric cutting tool, comprising such a transmission.

### BACKGROUND ART

A power tool, such as an electric cutting tool, generally comprises an electric motor, a tool bit (for example, a cutting blade) and a transmission for transmitting a force between the electric motor and the tool bit. The transmission generally comprises a gear transmission mechanism for transmitting the output rotational movement of the electric motor to the tool bit at a certain transmission ratio. For achieving a sufficient transmission ratio, the gear transmission mechanism is generally of the type of dual-stage or multi-stage, so that the sizes and positions of the gears can be set properly. However, more stages of the gear transmission mechanism result in a lager size of it. The gears, the shafts and the bearings of the gear transmission mechanism should be arranged in a compact manner to minimize the size of the gear transmission mechanism.

As an example, an electric cutting tool as shown in FIG. 1 is disclosed in Chinese patent publication CN101336146A, wherein a start-end side gear 7a is coupled with a motor shaft 6a, a final-end side gear 7b and a saw blade 1 are carried by a saw blade shaft 1a, a first gear 7c meshing with the start-end side gear 7a and a second gear 7d meshing with the final-end side gear 7b are carried by an intermediate gear shaft 14, the saw blade shaft 1a is supported by bearings 13 and 12 at its proximal and distal sides respectively, and the intermediate gear shaft 14 is supported by bearings 17 and 16 at its proximal and distal sides respectively, wherein the proximal side bearings 13 and 17 are needle bearings which do not function well under axial forces.

According to the solution disclosed in CN101336146A, the needle bearing 17 on the proximal side of the intermediate gear shaft 14 cannot endure an axial force, which results in deficiencies of the electric cutting tool. For example, such a configuration cannot be used in a reversely operable power tool (a tool having a tool bit that is rotatable in both forward and reverse directions). Further, the strength of the needle bearing itself is low. In addition, high vibration and noise are likely to be generated because the needle bearing has a large radial fitting clearance. These factors will negatively affect cutting precision, operation comfortability and life time of the power tool.

### SUMMARY OF THE INVENTION

An object of the disclosure is to provide an improved power tool which has a compact and/or durable structure.

For this end, the disclosure in one aspect provides a transmission for a power tool, the transmission comprising an input gear driven by a driver (for example, an electric motor) of the power tool; an intermediate shaft carrying first and second intermediate gears, the first intermediate gear being meshed with the input gear; an output shaft carrying an output gear, the output gear being meshed with the second intermediate gear for driving a tool bit of the power tool; and proximal and distal bearings supporting proximal and distal ends of the intermediate shaft respectively; wherein the first intermediate gear is formed with a receptacle portion which is recessed from a proximal end surface of the first intermediate gear in an axial direction towards a distal side, the proximal bearing being received in the receptacle portion at least in part in the axial direction. More specifically, the proximal bearing may be either located in the receptacle portion in part in the axial direction or located in the receptacle portion completely in the axial direction.

According to a preferred embodiment of the disclosure, each of the proximal bearing and the distal bearing is able to bear both an axial force and a radial force. For example, the proximal bearing and/or the distal bearing is a ball bearing or a conical roller bearing.

According to a preferred embodiment of the disclosure, the first intermediate gear is formed integrally with the intermediate shaft; alternatively, the first intermediate gear is formed separately and then fixed onto the intermediate shaft. On the other hand, the second intermediate gear is formed integrally with the intermediate shaft; alternatively, the second intermediate gear is formed separately and then fixed onto the intermediate shaft. The first and second intermediate gears are preferably proximate to each other in the axial direction.

According to a preferred embodiment of the disclosure, the proximal bearing comprises an inner ring which is supported by the proximal end of the intermediate shaft and an outer ring which is supported by a housing of the power tool. Alternatively, the proximal bearing comprises an inner ring which is supported by a housing of the power tool and an outer ring which is supported in the receptacle portion by the first intermediate gear, with an interference fit being formed between the outer ring and the receptacle portion.

The disclosure in a further aspect provides a power tool comprising a driver, a tool bit, and a transmission as described above, for transmitting an output movement of the driver to the tool bit.

The power tool is preferably an electric cutting tool, for example, a circular saw. Further, the power tool is preferably a portable power tool.

According to the disclosure, the proximal bearing on the intermediate shaft of the gear transmission mechanism of the power tool is accommodated at least partially in the axial direction in the receptacle portion formed in the first proximal intermediate gear, so that the gear transmission mechanism can be arranged in a compact manner. Further, the proximal and distal bearings are of the type that can endure both an axial force and a radial force, thus the supporting ability of the bearings on the intermediate shaft is increased. As a result, the power tool of the disclosure has a compact and/or durable overall structure. In addition, by forming the receptacle portion in the first proximal intermediate gear, the weight of it is reduced. Thus, the total weight of the movable elements and thus the energy loss can be reduced according to the disclosure.

Other features and benefits of the disclosure will be described later.

### BRIEF DESCRIPTION OF THE DRAWINGS

FIG. 1 is a schematic view of a gear transmission mechanism of an electric cutting tool according to prior art.

FIG. 2 is a schematic sectional view of a gear transmission mechanism of a power tool according a preferred embodiment of the disclosure.

FIG. 3 is a schematic sectional view of a portion around the intermediate shaft shown in FIG. 2.

FIG. 4 is a schematic sectional view of a portion around an intermediate shaft according to another preferred embodiment of the disclosure.

FIG. 5 is a schematic sectional view of a portion around an intermediate shaft according to yet another preferred embodiment of the disclosure.

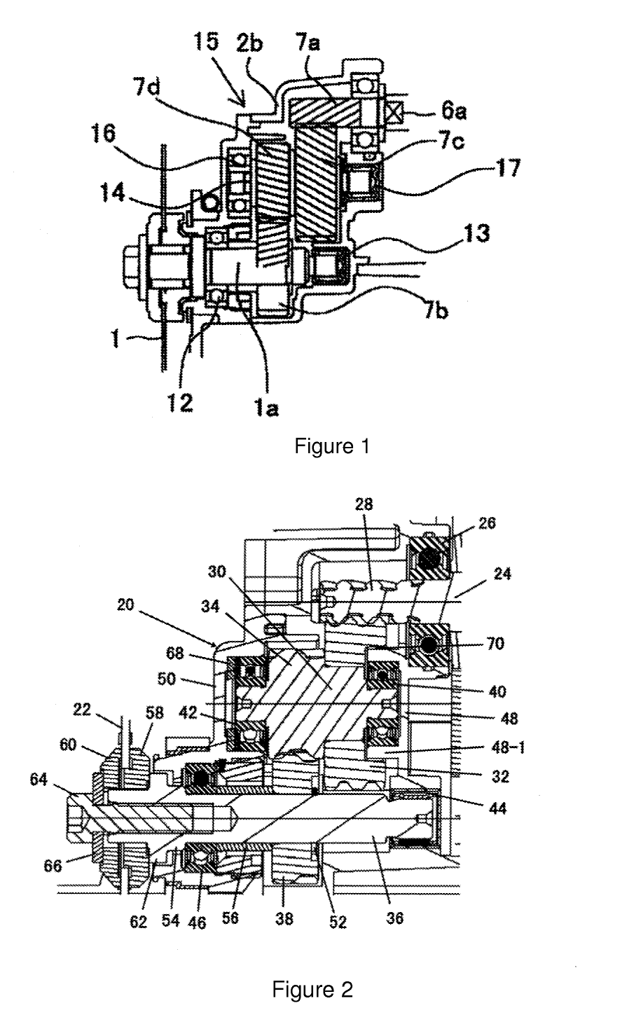

### DETAILED DESCRIPTION OF PREFERRED EMBODIMENTS

Now some illustrative preferred embodiments of the disclosure will be described with reference to the drawings.

The disclosure relates to power tools, in particular portable power tools, such as saws, drills, grinding tools and the like, which may comprise various gear transmission mechanisms. A circular saw is used here as an example for describing the principle of the disclosure though, the disclosure is also applicable in other types of power tools.

FIG. 2 shows a portion of a circular saw (for example, a portable circular saw) according to a preferred embodiment of the disclosure. The circular saw comprises a housing 20, an electric motor (not shown) mounted in the housing 20, a saw blade (tool bit) 22 mounted at least partially outside the housing 20, and a transmission for transmitting the rotational movement and torque of the electric motor to the saw blade. The electric motor has a motor shaft 24 which is supported in the housing 20 by a bearing 26.

The transmission mainly comprises an input gear 28 carried by the motor shaft 24, a first proximal intermediate gear 32 and a second distal intermediate gear 34 carried by an intermediate shaft 30, and an output gear 38 carried by the output shaft 36.

The first intermediate gear 32 is meshed with the input gear 28, and the second intermediate gear 34 is meshed with the output gear 38. In this way, a duel-stage gear transmission mechanism is formed by these two pairs of gears, in which the transmission ratio (speed ratio) of each stage of transmission mechanism can be determined properly to obtain a combined total transmission ratio (speed ratio) between the electric motor and the saw blade 22. In the illustrated embodiment, the two pairs of gears are all cylindrical gears, so that the central axes of the motor shaft 24, the intermediate shaft 30 and the output shaft 36 are parallel with each other. However, the disclosure does not exclude the conditions that one or both of the two pairs of gears are in the form of bevel gears or other types of gears. Further, the teeth of the two pairs of gears are preferably skewed teeth as illustrated; however the disclosure does not exclude the condition that the teeth of one or both of the two pairs of gears are straight teeth.

The intermediate shaft 30 is disposed completely in the housing 20, with its proximal end and distal end respectively being supported by the housing 20 via bearings 40 and 42. The distal end of the output shaft 36 extends out from the housing 20, and the remaining portion of the distal end lies in the housing 20. The output shaft 36 is supported at its proximal end and at a portion between its middle portion and distal end by the housing 20 via bearings 44 and 46 respectively. Here “proximal” refers to a direction towards or a location near the electric motor, while “distal” refers to a direction towards or a location near the saw blade 22.

The input gear 28 is mounted to or formed integrally with the motor shaft 24. In order to provide a sufficient speed ratio, the number of the teeth of the input gear 28 should be small enough (or the diameter of the input gear should be small enough). Thus, it is preferred to form the input gear 28 integrally with the motor shaft 24, as illustrated. However, the input gear 28 may also be formed separately and then be fixed to the motor shaft 24. In this case, a defective input gear 28 can be exchanged easily.

The intermediate shaft 30 is disposed kinetically between the motor shaft 24 and the output shaft 36. The central axis of the intermediate shaft 30 may be coplanar with the central axis of the motor shaft 24 and the central axis of the output shaft 36; however, it may also be not coplanar with them.

For reasons related with assembling, the housing 20 may comprise at least two the housing portions 48 and 50, one of the two housing portions (for example, 50) being detachable from the other one (for example, 48).

Since the motor shaft 24 is subjected to a relatively large radial force during operation, the bearing 26 which carries the motor shaft 24 is preferably a ball bearing, having an inner ring mounted around the motor shaft 24 and an outer ring fixed in the housing portion 48, so that the motor shaft 24 is supported stably.

During operation of the circular saw, the proximal and distal ends of the intermediate shaft 30 is subjected to a relatively large radial force, thus the bearings 40 and 42 which carry the proximal and distal ends of the intermediate shaft 30 may be bearings having relatively large roller elements, for example, standard ball bearings. Further, during operation of the circular saw, the intermediate shaft 30 is also subjected to a certain axial force, thus the bearings 40 and 42 are preferably bearings that can bear an axial pushing force, such as one-direction thrust ball bearings, conical roller bearings or the like. The proximal bearing 40 is carried by a bearing support 48-1 of the housing portion 48, and is able to bear an axial force applied in the proximal direction from the intermediate shaft 30. The distal bearing 42 is carried by the housing portion 50, and mainly bears an axial force applied in the distal direction from the intermediate shaft 30. The bearing 42 has an outer ring which may abut against the housing portion 50 directly or abut against the housing portion 50 indirectly via a washer 68. The washer 68 is preferably formed of a material having vibration damping property for reducing vibrations generated during operation of the circular saw.

During operation of the circular saw, the proximal bearing 44 which carries the output shaft 36 is subjected to a relatively small radial force, and is subjected to nearly no axial pushing force. Thus, the bearing 44 may be of any suitable type, such as ball bearing, conical roller bearing, needle bearing or the like. For saving space, the bearing 44 is preferably a needle bearing as illustrated. The bearing 44 having an inner ring mounted around the output shaft 36 and an outer ring fixed in the housing portion 48.

The bearing 46 which carries the portion between the middle portion and the distal end of the output shaft 36 is supported by the housing portion 50. Thus, the location of the bearing 46 in the axial direction is distal from the bearing 42, so that a majority of the radial force from the output shaft 36 is taken by the bearing 46. For this purpose, the bearing 46 may be a bearing having relatively large roller elements, for example, a standard ball bearing. Further, during operation of the circular saw, the output shaft 36 may also be subjected to a certain axial force, thus the bearing 46 is preferably a bearing that can bear an axial pushing force, such as a one-direction thrust ball bearing, a conical roller bearing or the like.

The output gear 38 is fixedly mounted to a middle portion of the output shaft 36, for example, by means of a spring clamper 52. The bearing 46 has an inner ring mounted around the output shaft 36 and an outer ring fixed in the housing portion 50. The inner ring of the bearing 46 has a distal side which biases against a shoulder portion 54 on the output shaft 36 and a proximal side which is clamped tightly in the axial direction by the output gear 38 via a separation sleeve 56.

The saw blade 22 is clamped onto the distal end of the output shaft 36 by a saw blade clamping device. The saw blade clamping device comprises inner and outer clamping disks 58 and 60, with the inner clamping disk 58 biasing against a flange portion 62 on the output shaft 36, and the outer clamping disk 60 being locked tightly by a fastening screw 64 via a washer 66, so that the saw blade 22 is fixedly clamped between the inner and outer clamping disks 58 and 60. Of course, other types of saw blade clamping devices can be used alternatively.

As mentioned above, the proximal bearing 40 which carries the intermediate shaft 30 is a bearing which can bear a relatively large radial force (preferably can also bear a certain axial force), thus it has an inevitably large size. However, since the bearing 40 is located near the bearing 26 which carries the motor shaft 24, there is likely interference in the radial direction between them. In order to dispose the bearings 40 and 26 is a compact space without interference, the bearing 40 is displaced to the distal side so that it is misaligned from the bearing 26 in the axial direction according to the disclosure. Since the first intermediate gear 32 has a relatively large diameter (substantively larger than that of the input gear 28, and larger than that of the second intermediate gear 34 to some extent), it is possible to form a receptacle portion 70 in the first intermediate gear 32. The receptacle portion 70 is a space of a substantially cylindrical shape extending from a proximal side surface of the first intermediate gear 32 towards the distal side in the axial direction. The first intermediate gear 32 has a large size, thus it has a sufficient strength even if the receptacle portion 70 is formed in it.

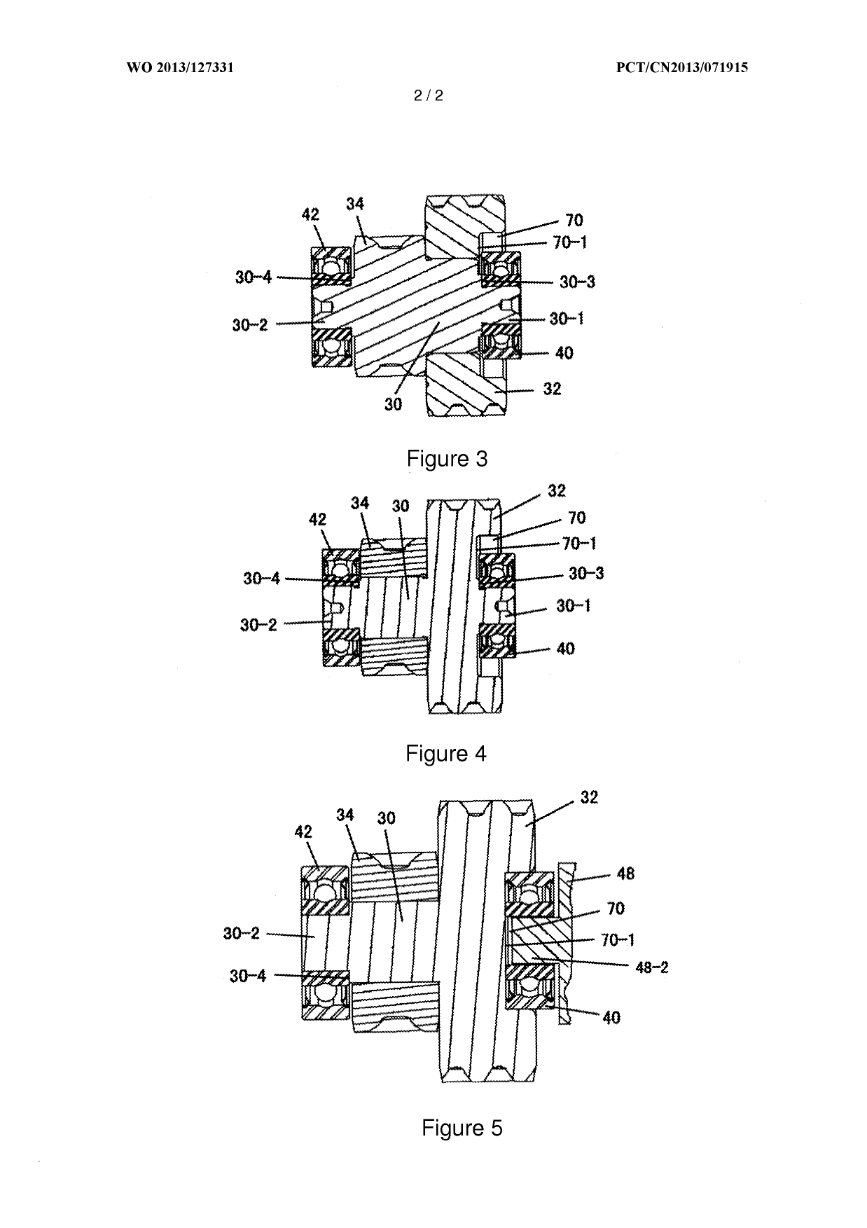

FIGS. 3 to 5 show some possible configurations of a portion around the intermediate shaft.

As shown in FIG. 3, according to an embodiment of the disclosure, the second intermediate gear 34 is formed integrally with the intermediate shaft 30, and the first intermediate gear 32 is formed separately and then fixed to the intermediate shaft 30. The distal end surface of the first intermediate gear 32 biases against the proximal end surface of the second intermediate gear 34. The intermediate shaft 30 comprises a proximal end 30-1 and a distal end 30-2 which have reduced diameters relative to that of the main portion of the intermediate shaft 30 respectively. Mounting shoulders 30-3 and 30-4 are formed respectively between the proximal end 30-1 and the distal end 30-2 and the main portion of the intermediate shaft 30. The inner ring of the bearing 40 is supported by the proximal end 30-1 and the mounting shoulder 30-3, and the outer ring of the bearing 40 is supported by the bearing support 48-1 of the housing portion 48 (not shown in FIG. 3). The inner diameter of the receptacle portion 70 is larger than the outer diameter of the bearing 40, so that a ring shaped space is formed therebetween for receiving the bearing support 48-1. The inner ring of the bearing 42 is supported by the distal end 30-2 and the mounting shoulder 30-4, and the outer ring of the bearing 42 is supported by a corresponding portion of the housing portion 50 (not shown in FIG. 3).

The proximal end 30-1 extends through the receptacle portion 70 in the first intermediate gear 32 in the axial direction towards the proximal side, and the proximal end surface of the proximal end 30-1 extends preferably beyond the proximal end surface of the first intermediate gear 32 in the axial direction towards the proximal side. Further, for mounting the bearing 40, the proximal end surface of the shoulder 30-3 lies beyond a bottom surface 70-1 of the receptacle portion 70 which faces towards the proximal side in the axial direction towards the proximal side.

A locating member (not shown) can be used for preventing relative rotation between the first intermediate gear 32 and the intermediate shaft 30, so that the first intermediate gear 32 is able to drive the intermediate shaft 30 to rotate with it. Preferably, this locating member or an additional locating member may prevent the first intermediate gear 32 from moving relative to the intermediate shaft 30 in the axial direction towards the proximal side.

FIG. 4 shows another embodiment of the intermediate shaft portion, wherein the first intermediate gear 32 is formed integrally with the intermediate shaft 30, and the second intermediate gear 34 is formed separately and then fixed to the intermediate shaft 30. The proximal end surface of the second intermediate gear 34 biases against the distal end surface of the first intermediate gear 32. The proximal end 30-1 and the distal end 30-2 of the intermediate shaft 30 have reduced diameter relative to that of the main portion of the intermediate shaft 30 respectively, so that mounting shoulders 30-3 and 30-4 are formed between the proximal and distal ends 30-1 and 30-2 on one hand and the main portion of the intermediate shaft 30 on the other hand respectively. The proximal end 30-1 extends in the receptacle portion 70 in the axial direction towards the proximal side, and the proximal end surface of the proximal end 30-1 extends preferably beyond the proximal end surface of the first intermediate gear 32 in the axial direction towards the proximal side. Further, for mounting the bearing 40, the shoulder 30-3 protrudes in the axial direction towards the proximal side from the bottom surface 70-1 of the receptacle portion 70 which faces towards the proximal side.

The inner ring of the bearing 40 is supported by the proximal end 30-1 and the mounting shoulder 30-3, and the outer ring of the bearing 40 is supported by the bearing support 48-1 of the housing portion 48 (not shown in FIG. 4). The inner diameter of the receptacle portion 70 is larger than the outer diameter of the bearing 40, so that a ring shaped space for receiving the bearing support 48-1 is formed therebetween. The inner ring of the bearing 42 is supported by the distal end 30-2 and the mounting shoulder 30-4, and the outer ring of the bearing 42 is supported by a corresponding portion of the housing portion 50 (not shown in FIG. 4).

Other aspects of the embodiment shown in FIG. 4 are similar to that of the embodiment shown in FIG. 3 and are not described again.

FIG. 5 shows yet another embodiment of the intermediate shaft portion, wherein the first intermediate gear 3 is formed integrally with the intermediate shaft 30, and the second intermediate gear 34 is formed separately and then fixed to the intermediate shaft 30. The proximal end surface of the second intermediate gear 34 biases against the distal end surface of the first intermediate gear 32. The distal end 30-2 of the intermediate shaft 30 has a reduced diameter relative to that of the main portion of the intermediate shaft 30, so that a mounting shoulder 30-4 is formed between the distal end 30-2 and the main portion of the intermediate shaft 30.

The proximal end of the intermediate shaft 30 is terminated at a bottom surface 70-1 of the receptacle portion 70 which faces towards the proximal side, rather than protruding from the bottom surface 70-1.

The inner ring of the bearing 42 is supported by the distal end 30-2 and the mounting shoulder 30-4, and the outer ring of the bearing 42 is supported by a corresponding portion of the housing portion 50 (not shown in FIG. 5). The inner ring of the bearing 40 is supported by the bearing support 48-2 of the housing portion 48, and the outer ring of the bearing 40 is supported by the first intermediate gear 32. More specifically, the inner diameter of an inner cylindrical wall defined in the receptacle portion 70 corresponds to the outer diameter of the bearing 40, with interference fit formed therebetween, so that the outer ring of the bearing 40 is kept and supported in the receptacle portion 70.

Other aspects of the embodiment shown in FIG. 5 are similar to that of the embodiments shown in FIGS. 3 and 4 and are not described again.

As an alternative to the embodiment shown in FIG. 5, the second intermediate gear 34 may be formed integrally with the intermediate shaft 30, and the first intermediate gear 32 may be formed separately and then fixed to the intermediate shaft 30.

It is appreciated that, in a possible embodiment which is not shown, the first intermediate gear 32 and the second intermediate gear 34 may both be formed integrally with the intermediate shaft 30; alternatively, the first intermediate gear 32 and the second intermediate gear 34 may both be formed separately and then fixed to the intermediate shaft 30.

Further, in the embodiments described above, the axial length of the receptacle portion 70 may be smaller than the axial length or the width of the bearing 40, in order to avoid significant reducing of the strength of the first intermediate gear 32 caused by forming the receptacle portion 70. In this case, the bearing 40 is located in part in the axial direction in the receptacle portion 70. However, the disclosure does not exclude the condition that the axial length of the receptacle portion 70 equals to or is larger than the axial length of the bearing 40. In other words, the disclosure covers both the conditions that the bearing 40 is located partly and completely in the receptacle portion 70.

According to the disclosure, the proximal bearing 40 of the intermediate shaft 30 is located at least partially in the axial direction in the receptacle portion 70 formed in the first proximal intermediate gear 32, so that the bearing 40 is misaligned in the axial direction with the bearing 26 on the motor shaft 24. In this way, sufficient accommodating spaces in radial direction are provided for both the bearings 40 and 26, so that the inner space in the housing 20 can be used efficiently, while the whole gear transmission mechanism can be disposed compactly.

Further, the proximal and distal ends of the intermediate shaft 30 are each supported by a bearing that can bear both a radial force and an axial force, thus the bearing on the intermediate shaft 30 can bear various loads that may be generated during operation of the circular saw. For example, even when the circular saw operates with its saw blade rotating in a reverse direction, the bearing on the intermediate shaft 30 can provide a sufficient support. As a result, the bearing on the intermediate shaft 30 is more durable, so that the life time of the whole the circular saw can be increased.

Furthermore, it is appreciated that, by using a dual-stage (or even multi-stage) gear transmission mechanism in the circular saw of the disclosure, and by disposing the gears of the gear transmission mechanism in a compact manner, the diameter of the output gear 38 can be reduced, and the cutting depth of the saw blade can be increased.

Furthermore, it is appreciated that, the basic principle of the disclosure, i.e., the proximal bearing on the intermediate shaft of the gear transmission mechanism is located at least partially in the axial direction in the receptacle portion formed in the first proximal intermediate gear, is also applicable in other types of power tools in which multi-stage gear transmission mechanisms are used, such as electric cutting tools, in particular portable electric cutting tools. In these cases, the technical effect of compactly disposing the gear transmission mechanism can be obtained similarly. Further, by forming the receptacle portion in the first proximal intermediate gear, the total weight of the movable elements and thus the energy loss can be reduced.

While certain embodiments of the disclosure have been described here, they are presented by way of explanation only and are not intended to limit the scope of the disclosure. Various modifications, substitutions and changes can be made by those skilled in the art within the scope and spirit of the disclosure as defined in the attached claims and their equivalents.

1. A transmission for a power tool, comprising:
an input gear driven by a driver of the power tool;
an intermediate shaft carrying a first intermediate gear and a second intermediate gear, the first intermediate gear being meshed with the input gear;
an output shaft carrying an output gear, the output gear being meshed with the second intermediate gear and configured to drive a tool bit of the power tool; and
a proximal bearing supporting a proximal end of the intermediate shaft and a distal bearing supporting a distal end of the intermediate shaft,
wherein the first intermediate gear is formed with a receptacle portion which is recessed from a proximal end surface of the first intermediate gear in an axial direction towards a distal side, the proximal bearing being received in the receptacle portion at least in part in the axial direction.

2. The transmission of claim 1, wherein each of the proximal bearing and the distal bearing is able to bear both an axial force and a radial force.

3. The transmission of claim 2, wherein one or more of the proximal bearing and the distal bearing is a ball bearing or a conical roller bearing.

4. The transmission of claim 1, wherein the first intermediate gear is formed integrally with the intermediate shaft.

5. The transmission of claim 4, wherein the second intermediate gear is formed integrally with the intermediate shaft, and wherein the first intermediate gear and the second intermediate gear are proximate to each other in the axial direction.

6. The transmission of claim 1, wherein the proximal bearing comprises an inner ring which is supported by the proximal end of the intermediate shaft and an outer ring which is supported by a housing of the power tool.

7. The transmission of claim 1, wherein the proximal bearing comprises an inner ring which is supported by a housing of the power tool and an outer ring which is supported in the receptacle portion by the first intermediate gear with an interference fit being formed between the outer ring and the receptacle portion.

8. A power tool, comprising:
a driver;
a tool bit; and
a transmission configured to transmit an output movement of the driver to the tool bit, the transmission including:
an input gear driven by the driver of the power tool;
an intermediate shaft carrying a first intermediate gear and a second intermediate gear, the first intermediate gear being meshed with the input gear;
an output shaft carrying an output gear, the output gear being meshed with the second intermediate gear and configured to drive the tool bit of the power tool; and
a proximal bearing supporting a proximal end of the intermediate shaft and a distal bearing supporting a distal end of the intermediate shaft,
wherein the first intermediate gear is formed with a receptacle portion which is recessed from a proximal end surface of the first intermediate gear in an axial direction towards a distal side, the proximal bearing being received in the receptacle portion at least in part in the axial direction.

9. The power tool of claim 8, wherein the power tool is configured as an electric cutting tool.

10. The power tool of claim 8, wherein the power tool is configured as a portable power tool.

11. The transmission of claim 1, wherein the first intermediate gear is formed separately from the intermediate shaft and is fixed onto the intermediate shaft.

12. The transmission of claim 11, wherein the second intermediate gear is formed separately from the intermediate shaft and is fixed onto the intermediate shaft, and wherein the first intermediate gear and the second intermediate gear are proximate to each other in the axial direction.

13. The power tool of claim 8, wherein the electric cutting tool is configured as a circular saw.
